(19) United States
(12) Patent Application Publication
(10) Pub. No.: US 2019/0187797 A1
(43) Pub. Date: Jun. 20, 2019

(54) DISPLAY MANIPULATION APPARATUS

(71) Applicant: DENSO CORPORATION, Kariya-city, Aichi-pref. (JP)

(72) Inventor: Fumio NAKAMURA, Kariya-city (JP)

(21) Appl. No.: 16/322,140

(22) PCT Filed: Jun. 15, 2017
(86) PCT No.: PCT/JP2017/022091

§ 371 Date: Jan. 31, 2019

(30) Foreign Application Priority Data
Aug. 2, 2016 (JP) 2016-152129

(51) Int. Cl. G06F 3/01; G06F 3/0488; G06F 3/0481

(52) U.S. Cl. CPC G06F 3/016; B60K 35/00; G06F 3/04817; G06F 3/04886

(57) ABSTRACT

In a display manipulation apparatus, a boundary line is defined around a detection target image to partition an inner area and an outer area. Under tracing manipulation in which a finger is moved continuously to trace two or more detection target images, in response to that a moving speed of the finger is equal to or less than a predetermined speed, a control circuit controls a vibration generator to be in an actuated state each time the finger passes through a position of the boundary line, whereas in response to that the moving speed is greater than the predetermined speed, the control circuit controls the vibration generator to be in a de-actuated state either (i) when the finger passes through a position of the boundary line and enters the inner area, or (ii) when the finger passes through a position of the boundary line and exits to the outer area.

### CROSS REFERENCE TO RELATED APPLICATION

The present application is based on Japanese Patent Application No. 2016-152129 filed on Aug. 2, 2016, the disclosure of which is incorporated herein by reference.

### TECHNICAL FIELD

The present disclosure relates to a display manipulation apparatus having a screen that allows a user's finger manipulation.

### BACKGROUND ART

There is conventionally known a display manipulation apparatus as described in Patent literature 1. The display manipulation apparatus (display input apparatus) of Patent literature 1 includes a display for displaying a plurality of detection target images (information input areas), a touch sensor for detecting information on position receiving finger manipulation on the display, a vibration generator for performing a vibration presentation by generating vibration in the touch sensor, and a display input control circuit for actuating the vibration generator according to the coordinate position of the finger at the time of the finger manipulation to vibrate the touch sensor.

A plurality of detection target images are arranged so as to be aligned with predetermined gaps in a predetermined direction. In addition, each of the plurality of detection target images is provided with a boundary line for partitioning between the inner side and the outer side of each detection target image area. Suppose that the finger manipulation corresponds to a tracing manipulation in which the finger traces the display surface of the display. Under such a tracing manipulation, when the finger passes through the boundary line, the display input control circuit actuates the vibration generator to thereby vibrate the touch sensor.

The user can thus recognize the position of the finger relative to the detection target image with the sense of touch.

### PRIOR ART LITERATURE

### Patent Literature

Patent Literature 1: JP 2013-073426 A

### SUMMARY OF INVENTION

In Patent literature 1, if the user is uncertain in the finger manipulation and continues performing a tracing manipulation over a plurality of detection target images aligned in a predetermined direction, the vibrations may occur successively when the finger exits from the inside to the outside of each detection target image and when the finger enters from the outside to the inside of each detection target image. At this time, if the moving speed of the finger performing the tracing manipulation is fast enough to exceed a predetermined speed, the vibrations are generated successively with a short cycle every time the finger crosses the boundary line. In such cases, the touch sensor behaves as if it is causing chattering vibration (resonance), which gives the user an unpleasant feeling.

It is an object of the present disclosure to provide a display manipulation apparatus capable of performing a vibration presentation with an excellent feeling when performing a tracing manipulation with respect to a plurality of detection target images arranged with predetermined gaps.

According to one example of the present disclosure, a display manipulation apparatus is provided to include a display, a touch panel, a vibration generator, and a control circuit. The display is configured to display a plurality of detection target images aligned with predetermined gaps. The touch panel is configured to be provided on a display surface of the display to detect a position of a finger due to a finger manipulation by a user who is manipulating the finger with respect to the plurality of detection target images. The vibration generator is configured to vibrate the touch panel. The control circuit is configured to control an actuation state of the vibration generator according to the position of the finger detected by the touch panel. Herein, a boundary line is defined around a detection target image to partition an inner area of the detection target image and an outer area of the detection target image. Under the finger manipulation being a tracing manipulation in which the finger is moved continuously with a moving speed of the finger to trace two or more detection target images, in response to that the moving speed of the finger is equal to or less than a predetermined speed, the control circuit controls the vibration generator to be in an actuated state each time the finger passes through a position of the boundary line. In contrast, under the finger manipulation being a tracing manipulation in which the finger is moved continuously with a moving speed of the finger to trace two or more detection target images, in response to that the moving speed of the finger is greater than the predetermined speed, the control circuit controls the vibration generator to be in a de-actuated state either (i) when the finger passes through a position of the boundary line and enters the inner area, or (ii) when the finger passes through a position of the boundary line and exits to the outer area.

As a result, when the moving speed of the finger exceeds the predetermined speed, the vibration generated by the vibration generator actuated when the finger exceeds the boundary line is thinned out, thereby suppressing the chattering vibration and giving the user a good feeling.

### BRIEF DESCRIPTION OF DRAWINGS

The above and other objects, features and advantages of the present disclosure will become more apparent from the following detailed description made with reference to the accompanying drawings. In the drawings:

FIG. 1 is an explanatory diagram showing a mounting position of a display manipulation apparatus in a vehicle;

FIG. 2 is a block diagram showing a display manipulation apparatus;

FIG. 3 is an explanatory diagram showing details of a display surface and vibration generation timing during a tracing manipulation in a first embodiment;

FIG. 4 is a flowchart showing control contents for performing a vibration presentation mainly when a manipulation using the sense of sight is performed in the first embodiment;

FIG. 5 is a flowchart showing control contents for performing a vibration presentation mainly when a manipulation without using the sense of sight is performed in the first embodiment;

FIG. 6 is an explanatory diagram showing details of a display surface and vibration generation timing during a tracing manipulation in a second embodiment; and

FIG. 7 is a flowchart showing control contents for performing a vibration presentation mainly when a manipulation without using the sense of sight is performed in the second embodiment.

### EMBODIMENT FOR CARRYING OUT INVENTION

The following describes a plurality of embodiments for carrying out the present disclosure, with reference to the drawings. In each embodiment, a constituent element corresponding to a constituent element in a preceding embodiment with a reference sign or numeral may be denoted by the same reference sign or numeral, to omit redundant explanation. When only a part of a configuration is described in an embodiment, another preceding embodiment may be applied to the other parts of the configuration. It may be possible not only to combine parts the combination of which is explicitly described in an embodiment, but also to combine parts of respective embodiments the combination of which is not explicitly described if any obstacle does not especially occur in combining the parts of the respective embodiments.

### First Embodiment

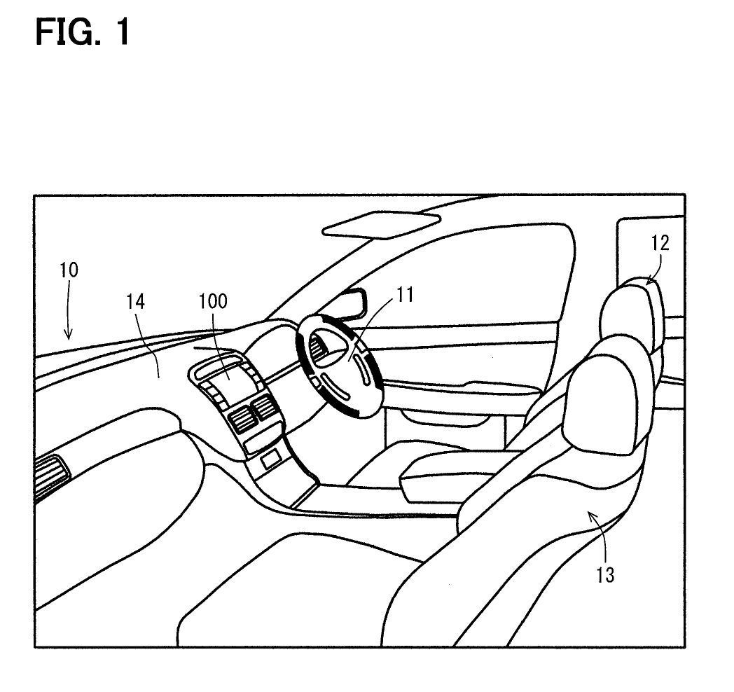

The following describes a display manipulation apparatus 100 according to a first embodiment with reference to FIGS. 1 to 5. The display manipulation apparatus 100 is provided to be used for a vehicle 10. As shown in FIG. 1, the vehicle 10 is a right-hand drive vehicle, the seat on the side of the steering wheel 11 is a driver seat 12, and the seat next to the driver seat 12 is a passenger seat 13.

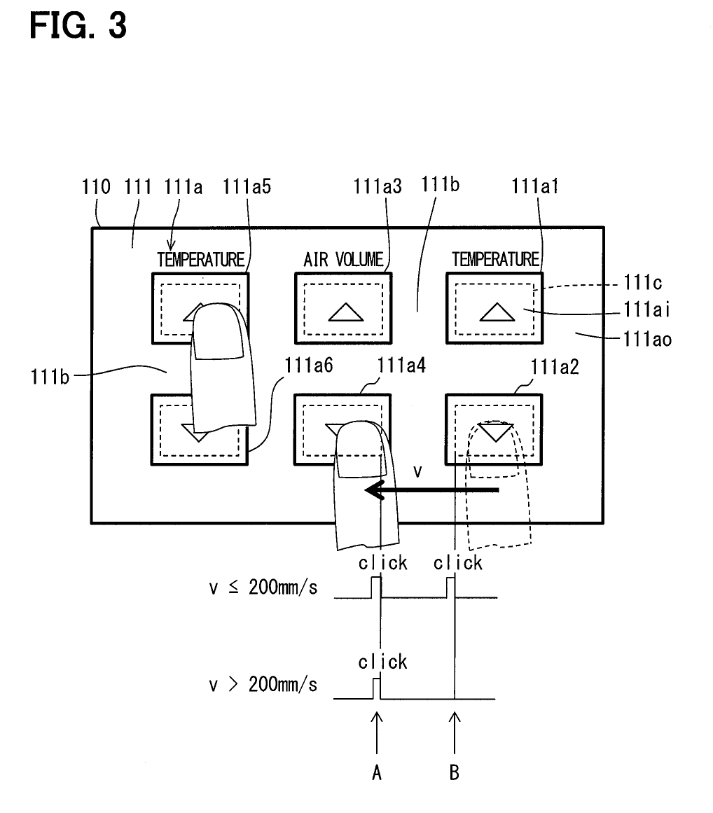

The display manipulation apparatus 100 is provided in a central portion in the left-right direction of an instrument panel 14 of the vehicle 10; the user can perform a finger manipulation on a touch panel 120. The finger manipulation performed by the user includes a touching manipulation, a tracing manipulation, and a depressing manipulation. The touching manipulation is a manipulation of touching the manipulation surface (a button icon 111a) of the touch panel 120 with a fingertip, like the finger at the upper left in FIG. 3. The tracing manipulation is a manipulation of moving the finger continuously to trace the manipulation surface (a plurality of button icons 111a), such as the left-right direction, the up-down direction, the oblique direction, or the like. The finger at the lower right in FIG. 3 indicates a tracing manipulation in the right to left direction. The depressing manipulation is a manipulation of pressing the touched position on the manipulation surface (on an intended button icon 111a), like the finger at the upper left in FIG. 3.

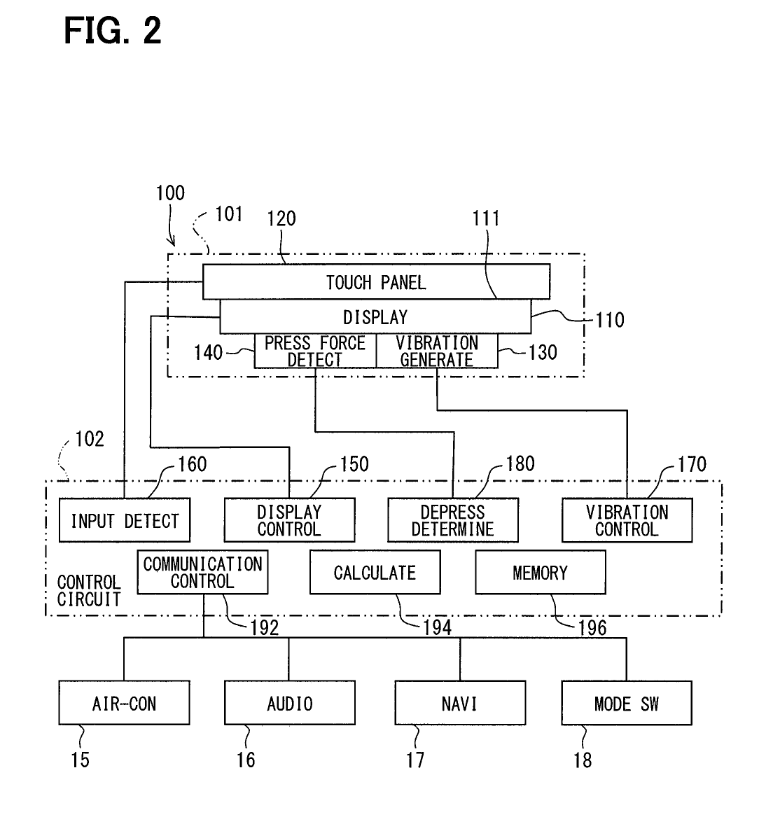

In the display manipulation apparatus 100, the control circuit 102 sets an actuation condition of a vehicle apparatus mounted on the vehicle based on a user's finger manipulation (input manipulation), while displaying an actuation state on the display 110 as an actuation state image. For example, as shown in FIG. 2, the vehicle apparatus includes a vehicle air-conditioning apparatus 15, a vehicle audio apparatus 16, a vehicle navigation apparatus 17, and a vehicle travel mode switching apparatus 18. In the present embodiment, the vehicle air-conditioning apparatus 15 will be described as a representative vehicle apparatus.

Further, in the display manipulation apparatus 100, in response to a user's finger manipulation, the touch panel 120 is vibrated by the vibration generator 130 (so-called vibration presentation is performed), and the user can obtain a sense of touch at their fingertip.

As shown in FIGS. 1 to 3, the display manipulation apparatus 100 includes a touch panel unit 101 and a control circuit 102. The touch panel unit 101 includes a display 110, a touch panel 120, a vibration generator 130, and a pressing force detector 140. In addition, the control circuit 102 includes a display controller 150, an input detector 160, a vibration controller 170, a depressing determination unit 180, a communication controller 192, a calculator 194, and a memory unit 196. The touch panel unit 101, which forms an input interface, is disposed in a central portion of the instrument panel 14 so as to be easy to be visible from the user and be easy to receive a finger manipulation (a touching manipulation, a tracing manipulation, a depressing manipulation, etc.) from the user. Further, the control circuit 102 is disposed inside of the instrument panel 14.

First, the configuration of the touch panel unit 101 will be described.

The display 110 is a display unit for displaying images with an oblique square shape (rectangular shape) as a front shape viewed from the user side, and is configured by a liquid crystal display, or an organic EL display. On a display surface 111 of the display 110, for example, various button icons 111a are displayed by the control circuit 102 (display controller 150) as images for inputting an actuation state or actuation condition of the vehicle air-conditioning apparatus 15.

The various button icons 111a correspond to detection target images of the present disclosure and icon images for input manipulation. The various button icons 111a include a plurality of different icons, as shown in FIG. 3, such as driver's temperature setting icons (111a1, 111a2) which receive a finger manipulation mainly by a driver, air volume setting icons (111a3, 111a4) which receive a finger manipulation by a driver or an assistant passenger, and temperature setting icons (111a5, 111a6) for a passenger's seat which receive a finger manipulation mainly by a assistant passenger. The icons 111a1 to 111a6 are arranged in the vertical direction and in the horizontal direction with respective gaps 111b, which have predetermined sizes, in between the icons 111a1 to 111a6.

The temperature setting icons (111a1, 111a2) for the driver, which are displayed on the driver side (right side) of the display 110, include a temperature increasing icon 111a1 for increasing the set temperature of an air-conditioning air and a temperature decreasing icon 111a2 for decreasing the set temperature of the air-conditioning air. The temperature increasing icon 111a1 and the temperature decreasing icon 111a2 are arranged in the vertical direction with a gap 111b.

The air volume setting icons (111a3, 111a4), which are displayed in the center of the display 110, include an air volume increasing icon 111a3 for increasing the air volume of the air-conditioning air and an air volume decreasing icon 111a4 for decreasing the air volume of the air-conditioning air. The air volume increasing icon 111a3 and the air volume decreasing icon 111a4 are arranged in the vertical direction with a gap 111b. Other gaps 111b are provided in between the air volume setting icons 111a3 and 111a4 and the temperature setting icons 111a1 and 111a2, respectively.

The temperature setting icons (111a5, 111a6) for the assistant passenger, which are displayed on the passenger side (left side) of the display 110, include a temperature amount increasing icon 111a5 for increasing the set temperature of the air-conditioning air and a temperature decreasing icon 111a6 for decreasing the set temperature of the air-conditioned air. The temperature amount increasing icon 111a5 and the temperature decreasing icon 111a6 are arranged in the vertical direction with a gap 111b. Other gaps 111b are provided between the temperature setting icons 111a5 and 111a6 and the air volume setting icons 111a3 and 111a4, respectively.

Around each of the icons 111a1 to 111a6, a boundary line 111c is defined for partitioning the inner area 111ai and the outer area 111ao from each other. In the present embodiment, the boundary line 111c is defined so as to be positioned slightly inward (by a predetermined length) from a position on an outline of each of the icons 111a1 to 111a6.

The touch panel 120 enables a finger manipulation (a touching manipulation, a tracing manipulation, a depressing manipulation, etc.) by a user's finger. The touch panel 120, which is transparent, is plate-like detector with an oblique square shape (rectangular shape) opposing the display surface 111 of the display 110; the touch panel 120 is provided so as to overlap the display surface 111 of the display 110. The surface of the touch panel 120 on which the finger manipulation is performed (the surface on the user side) serves as a manipulation surface. The actuation state of the vehicle apparatus (vehicle air-conditioning apparatus 15) on the display 110, and the icons 111a1 to 111a6 etc. are transmitted through the touch panel 120 and are visually recognized by the user.

The touch panel 120 may employ various types such as electrostatic capacitance type, resistance film type, ultrasonic surface acoustic wave type, optical type, or electromagnetic induction type. The present embodiment employs an electrostatic capacitance type (mutual capacitance type) touch panel 120. The electrostatic capacitance type touch panel 120 is provided with a plurality of transparent electrodes that are formed in a matrix shape. The touch panel 120 outputs, to the input detector 160, a change in electrostatic capacitance (a change signal of electrostatic capacitance) generated according to the position of the finger by the user's finger manipulation. Note that a protective cover plate may be provided on the manipulation surface of the touch panel 120.

The vibration generator 130, which is a vibrator for vibrating the touch panel 120, is connected to the control circuit 102 (vibration controller 170). The vibration generator 130 may employ a vibrator, a piezoelectric element (piezo element), a vibration motor, a linear actuator, or a voice coil motor. The vibration generator 130 employing a piezoelectric element may also function as a pressing force detector 140 which will be described later.

The pressing force detector 140 outputs a pressing signal based on a pressing force (load), to the depressing determination unit 180 when a depressing manipulation is performed on any one of the icons 111a1 to 111a6 on the touch panel 120. The pressing force detector 140 may output a detected pressing force signal as it is, or may output only a pressing force signal that has a value equal to or greater than a specified value.

The following describes a configuration of the control circuit 102.

The display controller 150 is an element that controls a display state of the display 110 based on various images previously stored in the memory unit 196 and actuation signals in various vehicle apparatuses (vehicle air-conditioning apparatus 15 etc.) obtained via the communication controller 192.

The input detector 160 is an element that detects a place or a movement (from where to where) of a finger of the user on the touch panel 120 based on the change signal of the electrostatic capacity output from the touch panel 120 at the time of the user's finger manipulation, to thereby grasp a coordinate position of the finger, a moving direction of the finger (tracing manipulation direction), a moving speed of the finger (tracing speed v), and the like.

The vibration controller 170 is an element that controls the actuation of the vibration generator 130 according to the user's finger manipulation. The vibration controller 170 actuates the vibration generator 130, when the button icon 111a is depressed by the finger manipulation or when the finger passes through the boundary line 111c (described later in detail). The vibration controller 170 vibrates the vibration generator 130 by controlling the application time of voltage or current when the vibration generator 130 is caused to vibrate according to the vibration pattern previously stored in the memory unit 196. The vibration pattern may employ a simple ON/OFF rectangular wave, a sine wave, or a composite wave of a low frequency and a high frequency.

The depressing determination unit 180 is an element that determines the presence or absence of a depressing manipulation on the touch panel 120 based on the pressing force signal output from the pressing force detector 140. The depressing determination unit 180 determines the presence or absence of a depressing manipulation based on whether or not the received pressing force signal exceeds a predetermined specified value (for example, 3N). Alternatively, suppose cases of receiving only a specific pressing force signal that is equal to or more than the specified value. In such case, when receiving such a specific pressing force signal, it is determined that a depressing manipulation is performed.

The communication controller 192, which is connected to each of the vehicle apparatuses (15 to 18) by a predetermined communication technique, is an element that obtains actuation signals of the respective vehicle apparatuses (15 to 18). Further, the communication controller 192 outputs an actuation condition for each of the vehicle apparatuses (15 to 18) in accordance with the user's finger manipulation.

The calculator 194 is an element that mainly performs calculation for controlling the display 110 and the vibration generator 130 based on the user's finger manipulation state obtained by the input detector 160 and the depressed state of the finger obtained by the depressing determination unit 180.

The memory unit 196, which is also referred to as a memory or a storage, is an element that stores (i) various images to be displayed on the display 110, (ii) vibration patterns when the vibration generator 130 is vibrated, and (iii) various determination values.

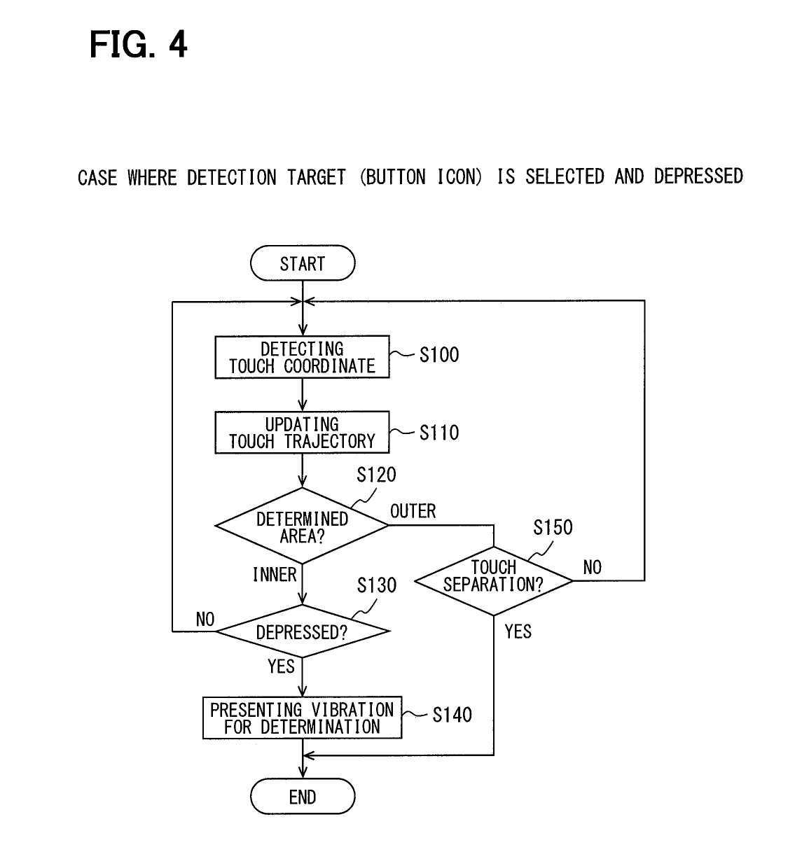

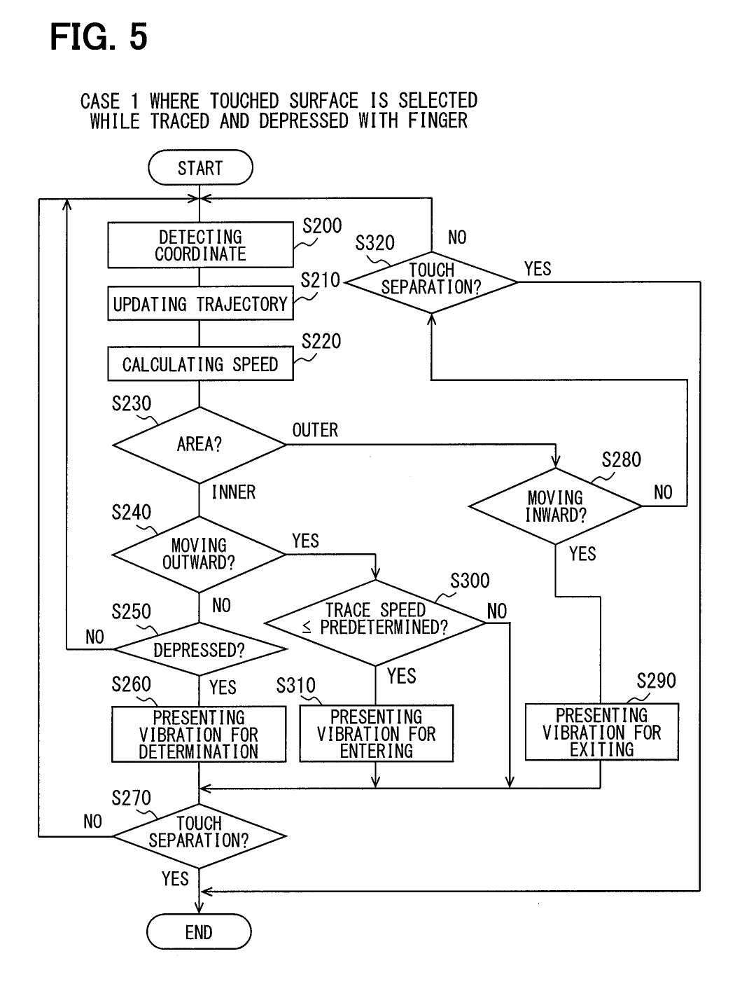

The display manipulation apparatus 100 is configured as described above. The following describes processes executed in the display manipulation apparatus 100 with FIGS. 4 and 5 added. In specific, the following describes the processes in which the control circuit 102 controls the vibration generator 130 according to the position and movement of the user's finger detected by the touch panel 120. The described flowchart includes a plurality of sections (also referred to as steps); each section is represented, for instance, as S100. Further, each section can be divided into several subsections, while several sections can be combined into one section. Each section can be referred to as a device or as a name indicating a structure. Also, the section may be achieved as (i) a software section in combination with a hardware unit (e.g., computer) or (ii) a hardware section (e.g., an integrated circuit or a wired logic circuit), including or not including a function of a related apparatus; furthermore, the hardware section may be constructed inside of a microcomputer.

1. Case where button icon is selected and depressed mainly by manipulation with using sense of sight

As shown in FIG. 4, in S100, the control circuit 102 first detects a coordinate position of a finger on the touch panel 120 by the touching manipulation by the user. In S110, a trajectory of the finger touching and tracing is updated with the lapse of time.

Then, in S120, the control circuit 102 determines whether the current coordinate position of the finger is within an inner area 111ai or an outer area 111ao in any one of the icons 111a1 to 111a6 by using the boundary line 111c.

When it is determined in S120 that the coordinate position of the finger is within the inner area 111ai, the control circuit 102 determines in S130 whether or not a depressing manipulation by the finger is performed based on the pressing force signal obtained from the pressing force detector 140. When a negative determination is made in S130, the control circuit 102 returns to S100.

On the other hand, when it is determined in S130 that a depressing manipulation is performed, the control circuit 102 determines that the user selects and depresses (determines) one of the icons. In S140, the control circuit 102 then actuates the vibration generator 130 to perform a vibration presentation that indicating an icon determination. At this time, the vibration allows the user to recognize that an intended icon is depressed.

When it is determined that the position of the finger is in the outer area 111ao in S120, the control circuit 102 determines in S150 whether a touch separation occurs which indicates that the finger is separated from the touch panel 120.

When it is determined that the touch separation occurs in S150, the control circuit 102 ends the present flowchart. When it is determined in S150 that any touch separation does not occur, the finger manipulation is determined to be continuing on the touch panel 120; then the control circuit 102 returns to S100.

2. Case where button icon is selected and depressed mainly by manipulation without using sense of sight

As shown in FIG. 5, in S200, the control circuit 102 first detects a coordinate position of the finger by the user's tracing manipulation (touching manipulation) on the touch panel 120. In S210, the trajectory of the finger tracing is updated with the lapse of time.

Then, in S220, the control circuit 102 calculates the moving speed (tracing speed) v of the finger in the tracing manipulation from the coordinate position of the finger and the trajectory of the finger that is moved with the lapse of time, and proceeds to S230.

In S230, the control circuit 102 determines whether the current coordinate position of the finger is within an inner area 111ai or an outer area 111ao in any one of the icons 111a1 to 111a6 using the boundary line 111c.

In S230, when it is determined that the coordinate position of the finger is within the inner area 111ai, the control circuit 102 determines in S240 whether or not the movement direction of the finger is outward (to the outer area 111ao) from the inner area 111ai.

When a negative determination is made in S240, the control circuit 102 determines in S250 whether or not a depressing manipulation by the finger is made based on the pressing force signal obtained from the pressing force detector 140. If a negative determination is made in S250, the control circuit 102 returns to S200.

On the other hand, when determining in S250 that a depressing manipulation is performed, the control circuit 102 determines that the user selects and depresses (determines) one of the icons; then, in S260, the control circuit 102 actuates the vibration generator 130 to perform a vibration presentation that indicates an icon determination. At this time, the vibration allows the user to recognize that the intended icon is depressed.

In S270, the control circuit 102 determines whether or not a touch separation occurs. When a negative determination is made, the control circuit 102 returns to S200; when an affirmative determination is made, the flowchart is ended.

In S230, when determining that the coordinate position of the finger is in the outer area 111ao, the control circuit 102 determines in S280 whether or not there is an inward movement of the finger toward the inner area 111ai.

When an affirmative determination is made in S280, the control circuit 102 actuates the vibration generator 130 regardless of the tracing velocity v when the finger passes through the boundary line 111c in S290, and performs a vibration presentation that indicates an area entering (A in FIG. 3). After S290, the control circuit 102 proceeds to S270.

In addition, when an affirmative determination is made in S240, the control circuit 102 determines in S300 whether the tracing speed v is equal to or less than a predetermined speed (for example, 200 mm/s) or not. When it is determined in S300 that the tracing speed v is equal to or less than the predetermined speed, the control circuit 102 actuates the vibration generator 130 when the finger passes through the boundary line 111c in S310, to perform a vibration presentation that indicates an area exiting. The control circuit 102 then proceeds to S270.

On the other hand, when it is determined in S300 that the tracing speed v is greater than the predetermined speed, the control circuit 102 sets the vibration generator 130 in a de-actuated state and does not perform any vibration presentation. Then, the control circuit 102 proceeds to S270 (B in FIG. 3).

When a negative determination is made in S280, the control circuit 102 determines whether a touch separation occurs in S320. When a touch separation occurs, the present flowchart is ended; when a touch separation does not occur, the control circuit 102 returns to S200.

The present embodiment described above is thus provided as follows. Suppose cases where a tracing manipulation is performed by the user and the finger enters an inner area 111ai. In such case, the vibration generator 130 is actuated regardless of the tracing speed v. In contrast, suppose cases where a tracing manipulation is performed and the finger exists to an outer area 111ao. In such cases, the vibration generator 130 is actuated when the tracing speed v is equal to or less than the predetermined speed whereas the vibration generator 130 is de-actuated when the tracing speed v is greater than the predetermined speed.

In other words, suppose cases where a tracing manipulation is performed by the user and the tracing speed v is equal to or less than the predetermined speed. In such cases, the vibration generator 130 is actuated each time the finger goes beyond the position of the boundary line 111c not only when entering the inner area 111ai but also when exiting to the outer area 111ao. In contrast, suppose cases where a tracing manipulation is performed and the tracing speed v is greater than the predetermined speed. In such cases, the vibration generator 130 is actuated only when entering by going beyond the boundary line 111c whereas the vibration generator 130 is de-actuated when exiting by going beyond the boundary line 111c. Further, in other words, suppose cases where a tracing manipulation is being detected and the tracing speed v is determined to be equal to or less than the predetermined speed. In such case, when either (i) an entering condition for the finger to enter an inner area 111ai beyond the boundary line 111c or (ii) an exiting condition for the finger to exit to an outer area 111ao beyond the boundary line 111c is satisfied, the vibration generator 130 is brought into an actuated state each time the finger goes beyond the position of the boundary line 111c. In contrast, suppose cases where a tracing manipulation is being detected and the tracing speed v is determined to be greater than the predetermined speed. In such cases, among the entering condition to enter an inner area 111ai beyond the boundary line 111c and the exiting condition to exit to an outer area 111ao beyond the boundary line 111c, when the entering condition is satisfied, the vibration generator 130 is brought into an actuated state whereas when the exiting condition is satisfied, the vibration generator 130 is brought into a de-actuated state.

As a result, when the tracing speed v of the finger is greater than the predetermined speed, the vibration generated by the vibration generator 130 actuated when the finger goes beyond the boundary line 111c is thinned out, thereby suppressing the chattering vibration and giving the user a good feeling.

### Second Embodiment

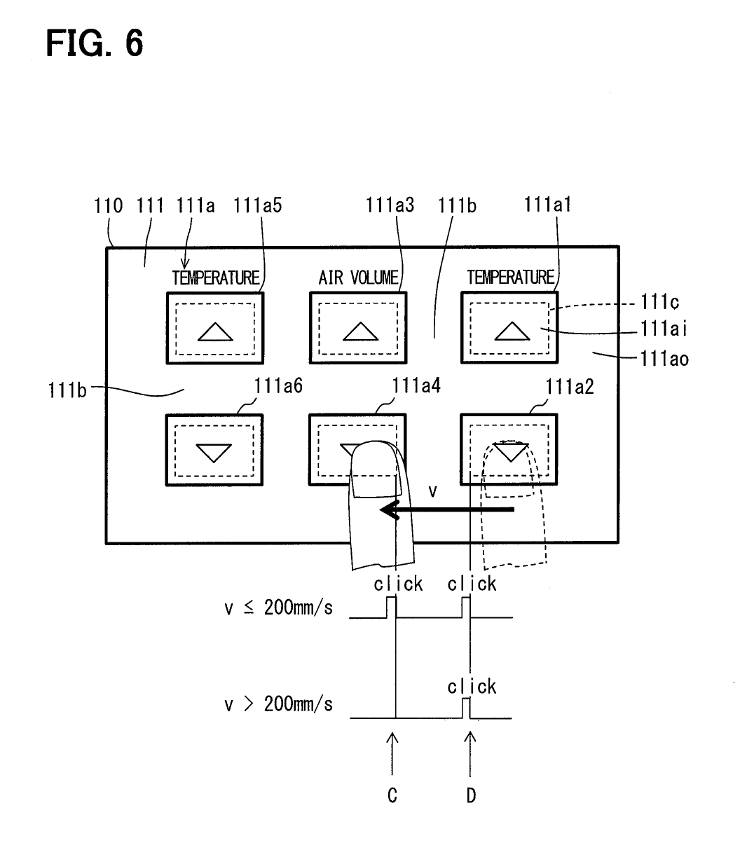

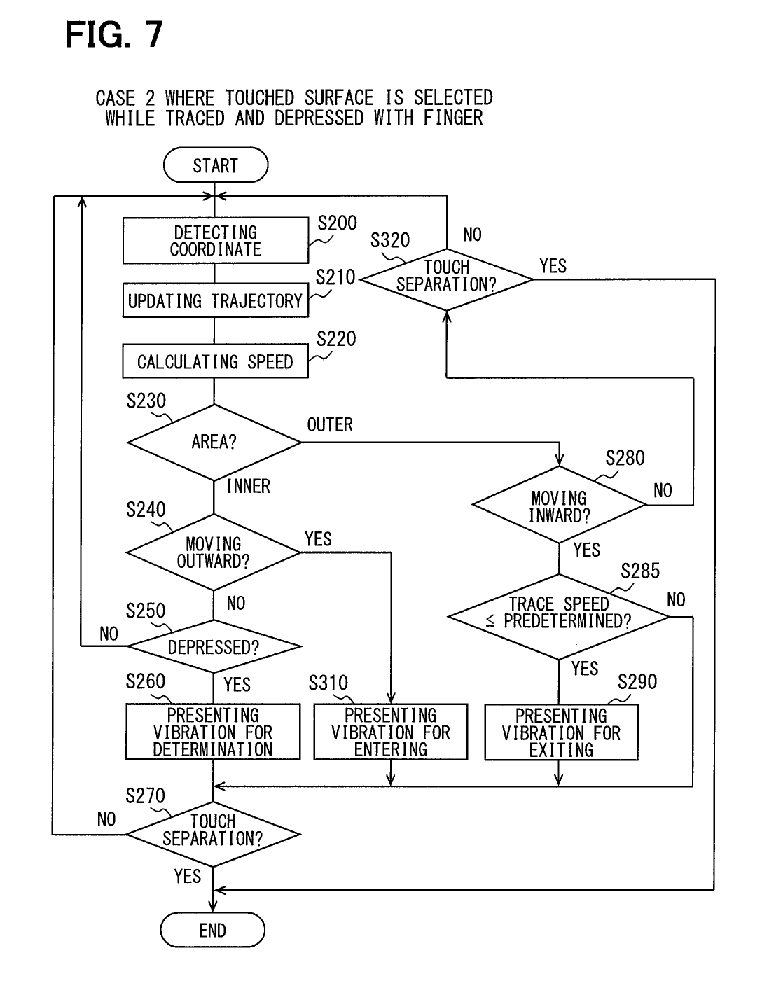

A second embodiment is shown in FIGS. 6 and 7. The display manipulation apparatus 100 according to the second embodiment has the same configuration as that of the first embodiment, but changes the control content of a vibration presentation. In FIG. 6, the condition for performing a vibration presentation is different from those in FIG. 3 described in the first embodiment. Further, the flowchart of FIG. 7 is a modification of that in FIG. 5 described in the first embodiment; namely, S300 is eliminated and S285 is added to thereby modify the conditions for executing S290 and S310.

In the flowchart of FIG. 7, under the tracing manipulation being performed, when, in S280, the control circuit 102 determines that a movement takes place toward an inner area 111ai, the control circuit 102 determines in S285 whether the tracing speed v is equal to or less than a predetermined speed (e.g., 200 mm/s).

When it is determined in S285 that the tracing speed is equal to or less than the predetermined speed, the control circuit 102 actuates in S290 the vibration generator 130 when the finger passes through the boundary line 111c, and thereby performs a vibration presentation indicating entering the inner area 111ai and then proceeds to S270.

On the other hand, when it is determined in S285 that the tracing speed exceeds the predetermined speed, the control circuit 102 sets the vibration generator 130 in a de-actuated state and does not perform any vibration presentation, then proceeding to S270 (C in FIG. 6).

Further, when determining in S240 that the movement direction of the finger is outward (to the outer area 111ao) from the inner area 111ai, the control circuit 102 actuates in S310 the vibration generator 130 when the finger passes through the boundary line 111c, regardless of the tracing speed v, to thereby perform the vibration presentation indicating exiting from the inner area 111ai (D in FIG. 6). After S310, the control circuit 102 proceeds to S270.

The present embodiment is thus provided as follows. Suppose cases where a tracing manipulation is performed by the user and the finger exits from the inner area 111ai. In such cases, the vibration generator 130 is actuated regardless of the tracing speed v. In contrast, suppose cases where a tracing manipulation is performed and the finger enters an inner area 111ai. In such cases, the vibration generator 130 is actuated when the tracing speed v is equal to or less than the predetermined speed whereas the vibration generator 130 is de-actuated when the tracing speed v is greater than the predetermined speed.

In other words, suppose cases where a tracing manipulation is performed by the user and the tracing speed v is equal to or less than the predetermined speed. In such cases, the vibration generator 130 is actuated each time the finger goes beyond the position of the boundary line 111c not only when entering the inner area 111ai but also when exiting to the outer area 111ao. In contrast, suppose cases where a tracing manipulation is performed and the tracing speed v is greater than the predetermined speed. In such cases, the vibration generator 130 is actuated only when exiting by going beyond the boundary line 111c whereas the vibration generator 130 is de-actuated when entering by going beyond the boundary line 111c. Further, in other words, suppose cases where a tracing manipulation is being detected and the tracing speed v is determined to be equal to or less than the predetermined speed. In such case, when either (i) an entering condition for the finger to enter an inner area 111ai beyond the boundary line 111c or (ii) an exiting condition for the finger to exit to an outer area 111ao beyond the boundary line 111c is satisfied, the vibration generator 130 is brought into an actuated state each time the finger goes beyond the position of the boundary line 111c. In contrast, suppose cases where a tracing manipulation is being detected and the tracing speed v is determined to be greater than the predetermined speed. In such cases, among the entering condition to enter an inner area 111ai beyond the boundary line 111c and the exiting condition to exit to an outer area 111ao beyond the boundary line 111c, when the entering condition is satisfied, the vibration generator 130 is brought into a de-actuated state whereas when the exiting condition is satisfied, the vibration generator 130 is brought into an actuated state.

As a result, similar to the first embodiment, when the tracing speed v of the finger is greater than the predetermined speed, the vibration generated by the vibration generator 130 actuated when the finger goes beyond the boundary line 111c is thinned out, thereby suppressing the chattering vibration and giving the user a good feeling.

### Other Embodiments

In each of the above embodiments, the vehicle air-conditioning apparatus 15 is mainly described as an example of a vehicle apparatus, but there is no need to be limited thereto. The vehicle audio apparatus 16, the vehicle navigation apparatus 17, and the vehicle travel mode switching apparatus 18 or the like may be described as an example of a vehicle apparatus.

In addition, although the present display manipulation apparatus is described as being mounted on a vehicle, there is no need to be limited thereto. The present display manipulation apparatus can be widely utilized such as for a stationary use, portable use, and the like.

Although the present disclosure has been described in accordance with the embodiments, it is understood that the present disclosure is not limited to the embodiments and structures disclosed therein. The present disclosure may cover various modification examples and equivalent arrangements. In addition, while the various elements are shown in various combinations and configurations, which are exemplary, other combinations and configurations, including more, less or only a single element, are also within the spirit and scope of the present disclosure.

What is claimed is:

1. A display manipulation apparatus comprising:
a display configured to display a plurality of detection target images aligned with predetermined gaps;
a touch panel configured to be provided on a display surface of the display to detect a position of a finger due to a finger manipulation by a user who is manipulating the finger with respect to the plurality of detection target images;
a vibration generator configured to vibrate the touch panel; and
a control circuit configured to control an actuation state of the vibration generator according to the position of the finger detected by the touch panel,
wherein:
a boundary line is defined around a detection target image to partition an inner area of the detection target image and an outer area of the detection target image;
under the finger manipulation being a tracing manipulation in which the finger is moved continuously with a moving speed of the finger to trace two or more detection target images,
in response to that the moving speed of the finger is equal to or less than a predetermined speed, the control circuit controls the vibration generator to be in an actuated state each time the finger passes through a position of the boundary line; and
under the finger manipulation being a tracing manipulation in which the finger is moved continuously with a moving speed of the finger to trace two or more detection target images,
in response to that the moving speed of the finger is greater than the predetermined speed, the control circuit controls the vibration generator to be in a de-actuated state either (i) when the finger passes through a position of the boundary line and enters the inner area, or (ii) when the finger passes through a position of the boundary line and exits to the outer area.

2. The display manipulation apparatus according to claim 1, wherein
under the finger manipulation being the tracing manipulation in which the finger is moved continuously with the moving speed of the finger to trace two or more detection target images,
in response to that the moving speed of the finger is greater than the predetermined speed, the control circuit controls the vibration generator to be in the de-actuated state when the finger passes though the position of the boundary line and exits to the outer area.

3. The display manipulation apparatus according to claim 1, wherein
under the finger manipulation being the tracing manipulation in which the finger is moved continuously with the moving speed of the finger to trace two or more detection target images,
in response to that the moving speed of the finger is greater than the predetermined speed, the control circuit controls the vibration generator to be in the de-actuated state when the finger passes through the position of the boundary line and enters the inner area.

4. The display manipulation apparatus according to claim 1, wherein
the detection target image is an icon image for an input manipulation to a vehicle apparatus used in a vehicle.
